(19) United States
(12) Patent Application Publication
(10) Pub. No.: US 2026/0344612 A1
(43) Pub. Date: Nov. 5, 2026

(54) MANIPULATION GRIPPER FOR STRETCHED CHEESE OF THE FRESH TYPE

(71) Applicant: Carmine MAROTTA, Nonantola, Modena (IT)

(72) Inventor: Carmine MAROTTA, Nonantola, Modena (IT)

(21) Appl. No.: 19/487,505

(22) PCT Filed: May 23, 2024
(86) PCT No.: PCT/IB2024/055032

§ 371 Date: Nov. 25, 2025

(30) Foreign Application Priority Data
May 25, 2023 (IT) 102023000010602

(51) Int. Cl. A01J 25/00; A01J 25/12; B25J 11/00; B25J 15/00

(52) U.S. Cl. CPC A01J 25/008; A01J 25/123; B25J 11/0045; B25J 15/0028

(57) ABSTRACT

The manipulation gripper (1) comprises one working assembly (6) comprising at least one gripping unit (7) provided with a pair of mutually movable gripping portions (8) to grip/release the cheese (F), where the working assembly (6) comprises one holding body (9) provided with a resting surface (10) adapted to hold the cheese (F) and the manipulation gripper (1) comprises one shifting unit (11) positioned between the gripping unit (7) and the holding body (9) and adapted to mutually move the gripping unit (7) and the holding body (9) along an operational direction (T) between a first position, wherein the resting surface (10) is moved away from the gripping portions (8) and the latter are adapted to intercept the cheese (F), and a second position, wherein the resting surface (10) is arranged in the proximity to the gripping portions (8) and is adapted to hold the cheese (F).

### TECHNICAL FIELD

The present invention relates to a manipulation gripper for stretched cheese of the fresh type.

### BACKGROUND ART

In the dairy sector, the production and processing of stretched cheese of the fresh type, such as mozzarella, is well known.

It is common for stretched cheese of the fresh type to be transferred from a supply station, defined e.g. on a forming machine, to a subsequent processing machine, such as e.g. a burrata production machine.

Such cheese is generally processed at high temperatures, comprised between 50 °C and 70 °C, in order to maintain high elasticity and deformability of the stretched texture.

For this reason, transfer operations must be carried out quickly in order to preserve the elastic properties of the stretched texture and are generally done manually by an operator.

However, it is easy to appreciate how manipulating cheese at high temperatures is a rather unpleasant and moreover detrimental operation to the health of the operators themselves and can cause the operator to grip the cheese improperly, thus risking compromising its elastic properties and/or the aesthetic appearance of the finished product.

In addition, the risk of contamination related to the manual work of such fresh cheese should not be underestimated which may, in turn, affect the quality of the finished product. Importantly, alterations in the quality of such fresh cheese greatly affect the degree of customer satisfaction, who may be disincentivized to repeat the purchase of the product.

In order to partly overcome these drawbacks, the use of manipulation gripper for sagging food products, such as fruits and vegetables, is well known in the food industry.

Manipulation grippers are generally mounted on automated positioning means, such as e.g. articulated arms, anthropomorphic robots or the like, responsible for the movement of the grippers themselves.

Specifically, known manipulation grippers comprise a base support associable with automated positioning means and a gripping unit, which is associated with the base support and provided with a pair of mutually movable gripping portions to grip/release the cheese.

However, manipulation grippers of known type are not effectively applicable in the dairy industry because the interaction of the gripping portions with the hot, highly elastic and deformable stretched texture can affect the aesthetic appearance of the cheese.

In addition, during transfer, the stretched texture can be deformed by gravity leading to precisely an alteration in the conformation of the cheese, with possible difficulties in the subsequent processing operations.

In fact, it is worth noting that in order to be subjected to certain types of processing, the cheese must maintain its conformation unchanged from the supply station to the processing machine. For example, in the case of burrata cheese, it is necessary for the mozzarella to maintain a substantially spheroidal conformation.

It is evident, therefore, that manipulation grippers of known type are susceptible to refinements.

### DESCRIPTION OF THE INVENTION

The main aim of the present invention is to devise a manipulation gripper for stretched cheese of the fresh type which allows reducing the risk of alterations in the appearance and, in particular, in the conformation of the cheese.

Another object of the present invention is to devise a manipulation gripper for stretched cheese of the fresh type which allows quick and efficient transfer of cheese so as to preserve the elasticity and deformability thereof.

A further object of the present invention is to devise a manipulation gripper for stretched cheese of the fresh type which allows minimizing the risk of bacterial contamination.

Another object of the present invention is to devise a manipulation gripper for stretched cheese of the fresh type which allows the aforementioned drawbacks of the prior art to be overcome within the framework of a simple, rational, easy and effective to use as well as affordable solution.

The aforementioned objects are achieved by this manipulation gripper having the characteristics of claim 1.

### BRIEF DESCRIPTION OF THE DRAWINGS

Other characteristics and advantages of the present invention will become more apparent from the description of a preferred, but not exclusive, embodiment of a manipulation gripper for stretched cheese of the fresh type, illustrated by way of an indicative, yet non-limiting example in the attached tables of drawings in which:

FIG. 1 is an axonometric view of a cheese transfer equipment provided with the manipulation gripper according to the invention and with a cheese processing machine;

FIG. 2 is an axonometric view of the manipulation gripper according to the invention;

FIG. 3 is a partly cross-sectional side view of the manipulation gripper according to the invention, in the second position;

FIG. 4 is a partly cross-sectional side view of the manipulation gripper according to the invention, in the first position;

FIG. 5 is a partly cross-sectional side view of the manipulation gripper according to the invention, at a cheese transfer stage;

FIG. 6 is a partly cross-sectional side view of the manipulation gripper according to the invention, at a cheese release stage.

### EMBODIMENTS OF THE INVENTION

With particular reference to these figures, reference numeral 1 globally denotes a manipulation gripper for stretched cheese of the fresh type.

The manipulation gripper is intended for the manipulation of stretched cheese of the fresh type.

In the context of this disclosure, the expression “stretched cheese of the fresh type” refers to a dairy product obtained by processing ripe curd with boiling water to obtain precisely a homogeneous texture, which is formed according to the desired conformation.

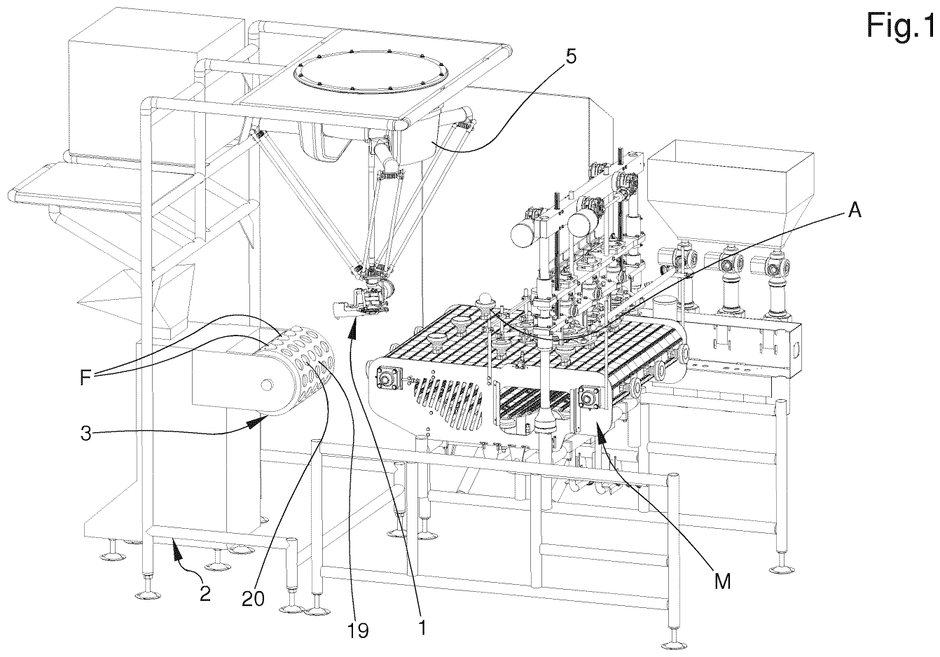

In particular, FIG. 1 shows a possible application of the manipulation gripper wherein it is used in a piece of equipment 2 for the transfer of stretched cheese of the fresh type.

In more detail, the manipulation gripper 1 can be used for the transfer of cheese F from a supply station 3, defined e.g. on a forming machine, to a cheese processing machine M, specifically a burrata production machine.

In this particular case, therefore, cheese F is mozzarella, a stretched cheese of the fresh type characterized by a substantially spheroidal shape.

In this regard, it is worth specifying that, as is well known, the production processes of filled cheese generally involve hot processing of the cheese in order to preserve the elasticity and deformability of the texture and to allow the filling to take place while avoiding tearing and/or breakage. Specifically, the cheese is processed at a temperature between of 50 °C and 70 °C.

It is easy to appreciate how, at such temperatures, the manipulation of the cheese by an operator is a rather unpleasant and detrimental operation to the operator's health, and can cause the operator to grip the cheese improperly, risking compromising its elastic properties and/or appearance.

The use of a manipulation gripper is therefore extremely advantageous for this application.

In addition, the manipulation gripper makes it possible to speed up transfer operations of cheese and prevents excessive cooling of the same.

Again, the use of a manipulation gripper helps to increase the hygienic conditions of the finished product.

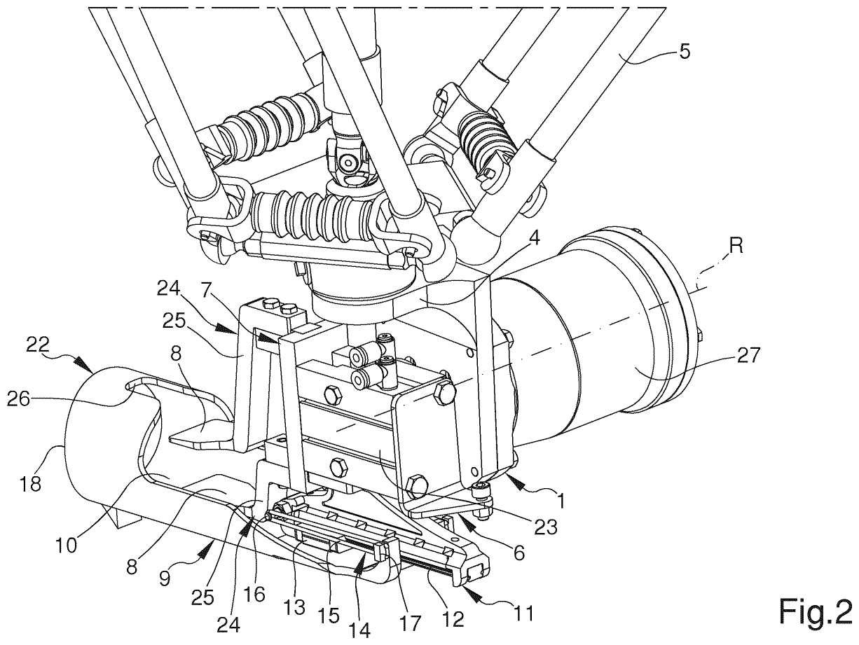

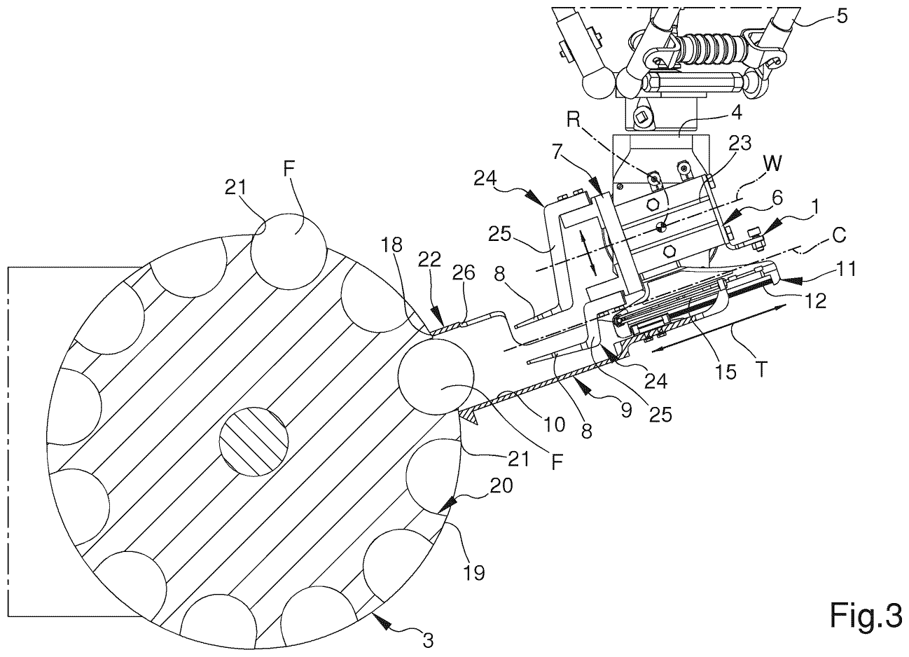

The manipulation gripper 1, shown in greater detail in FIGS. 2 through 6, comprises:
at least one base support 4 associable with automated positioning means 5 adapted to transfer the cheese F from the supply station 3 to the machine M making the cheese F; and
at least one working assembly 6 associated with the base support 4 and adapted to grasp and hold the cheese F.

In more detail, in accordance with the embodiment shown in FIG. 1, the automated positioning means 5 comprise a delta robot.

As known to the engineer in the field, a delta robot is a type of parallel robot involving the use of arms made in a parallelogram pattern which can maintain the orientation of the end. In other words, the automated positioning means 5 allow the manipulation gripper 1 to move along the three Cartesian axes but prevent it from rotating.

The delta robot enables very rapid movement of the cheese F, thus preventing excessive cooling of the cheese itself. In addition, unlike other types of automated devices, the delta robot allows significantly large working volumes to be achieved while maintaining very small overall dimensions.

It cannot, however, be ruled out that the automated positioning means 5 comprise a different type of device, e.g., of the type of an anthropomorphic robotic arm or of a collaborative robot.

The working assembly 6 comprises at least one gripping unit 7 provided with a pair of mutually movable gripping portions 8 to grip/release the cheese F. The gripping unit 7 will be described in more detail later in this disclosure.

According to the invention, the working assembly 6 also comprises at least one holding body 9 provided with a resting surface 10 adapted to hold the cheese F. In actual facts, the working assembly 6 allows the cheese F to be both retained and supported and avoids any possible gravity-induced deformation of the stretched texture.

Also in accordance with the invention, the manipulation gripper 1 comprises at least one shifting unit 11 positioned between the gripping unit 7 and the holding body 9 and adapted to mutually move the gripping unit 7 and the holding body 9 along one operational direction T between at least a first position, wherein the resting surface 10 is moved away from the gripping portions 8 and the latter are adapted to intercept the cheese F, and at least a second position, wherein the resting surface 10 is arranged in the proximity of the gripping portions 8 and is adapted to hold the cheese F.

Specifically, the shifting unit 11 is configured to move the holding body 9 with respect to the shifting unit 11.

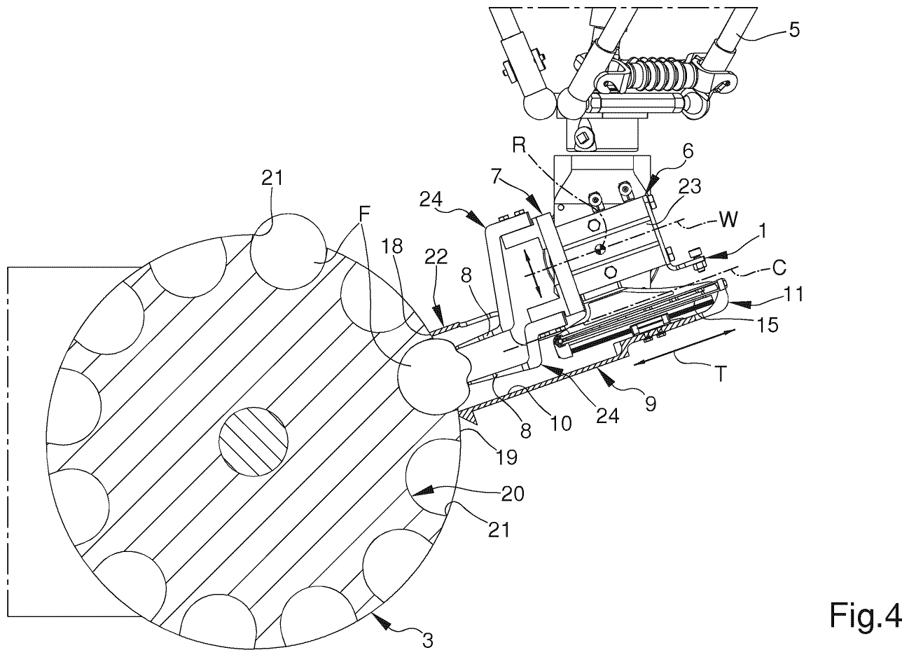

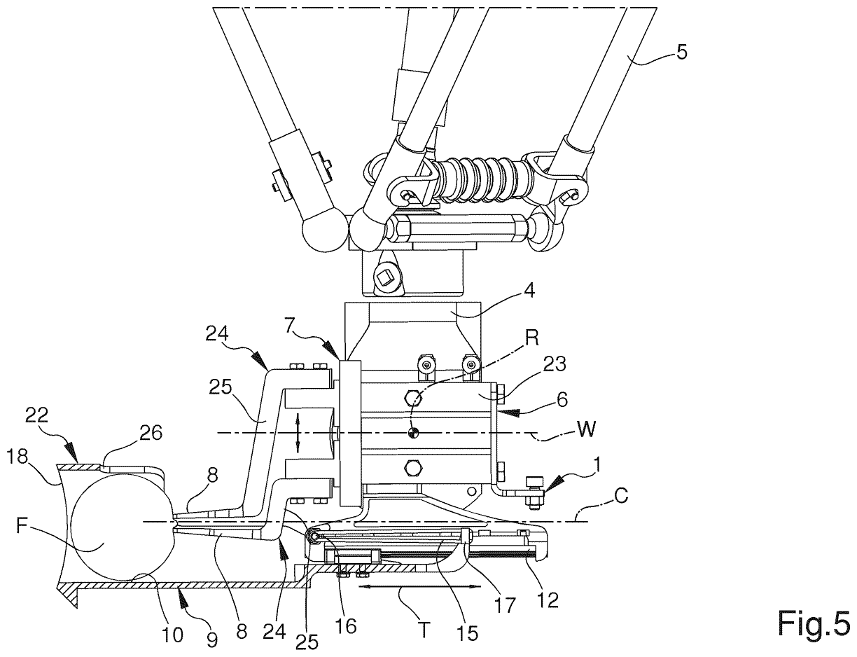

In the first position (FIG. 4), the resting surface 10 is substantially moved away from the gripping portions 8 to allow the cheese F to be grasped, and once the latter is grasped, the holding body 9 is shifted to the second position (FIG. 5) to allow the cheese itself to be supported on the resting surface 10.

In accordance with the embodiment shown in the figures, the operational direction T belongs to a substantially vertical plane.

Conveniently, the shifting unit 11 comprises at least one guiding element 12 associated with the gripping unit 7, extending along the operational direction T and supporting the holding body 9 by sliding between the first position and the second position.

The guiding element 12 is of the type of a linear guide and the holding body 9 is associated therewith through a slide element 13.

Advantageously, the shifting unit 11 comprises retaining means 14 adapted to retain the holding body 9 in the second position.

The holding body 9 is movable from the second position to the first position as a result of the movement of the manipulation gripper 1 against the supply station 3.

Specifically, the automated positioning means 5 are configured to arrange the manipulation gripper 1 in contact with the supply station 3 and to push it against them so as to cause the holding body 9 to shift towards the first position (FIG. 4).

In the absence of forces acting on the holding body 9, the latter is held in the second position by the retaining means 14.

Once the cheese F is grasped, the automated positioning means 5 move the manipulation gripper 1 away from the supply station 3 to proceed with the transfer of the cheese F and, at the same time, the retaining means 14 move the holding body 9 back to the second position (FIG. 5).

In this way, the manipulation gripper 1 ensures effective support of the cheese F as soon as it is picked up from the supply station 3.

Conveniently, the retaining means 14 comprise at least one elastic retaining element 15 positioned between the holding body 9 and the guiding element 12. The elastic retaining element 15 is of the type of an elastic lace closed on itself in a loop.

The gripping unit 7 comprises an attachment pin 16 and the holding body comprises an attachment portion 17 around which the elastic retaining element 15 is partly wrapped.

With the holding body 9 in the second position, the elastic retaining element 15 has a minimum elastic tension, which is sufficient to remain anchored to the gripping unit 7 and to the holding body 9, while with the holding body 9 in the first position, the elastic retaining element 15 has a maximum elastic tension, such that the holding body 9 is moved back to the second position in the absence of any further forces acting thereon.

Advantageously, the retaining means 14 comprise two elastic retaining elements 15 arranged opposite each other with respect to the plane to which the operational direction T belongs. At the same time, the gripping unit 7 comprises a pair of attachment pins 16 and the holding body comprises a pair of attachment portions 17.

Conveniently, the holding body 9 comprises a contact area 18 adapted to contact the supply station 3.

The contact area 18 is arranged transversely to the operational direction T.

The contact area is configured to adhere at least partly to an outer surface 19 of the supply station 3.

In detail, as shown above, in accordance with the embodiment shown in the figures, the supply station 3 can be defined on a forming machine.

Forming machines are familiar to the industry technician and comprise a supply system of the stretched texture and a forming drum designed to divide the stretched texture into portions and to give them their characteristic spheroidal shape.

In this particular case, therefore, the supply station 3 is of the type of a forming drum.

Thus, the forming station comprises a substantially cylindrical outer surface 19 and a plurality of housing seats 20, each adapted to contain a respective cheese F.

The manipulation gripper 1 is configured to pick up the cheese F from the housing seat 20.

In detail, the housing seats 20 have a substantially hemispherical conformation, are recessed from the outer surface 19 and define a circular opening 21 therewith. Subsequently to forming, therefore, the cheese F is arranged within the housing seat 20 and, for this reason, in order to allow it to be picked up by the gripping portions 8, the holding body 9 must be shifted towards the first position.

Conveniently, the holding body 9 comprises an extremal portion 22 having a substantially cylindrical conformation and defining the resting surface 10 and the contact area 18.

Such a conformation makes it possible to better hold the cheese F and avoid the deformation thereof during transfer.

Thus, the contact area 18 has a substantially annular development.

In more detail, the extremal portion 22 has an inner diameter equal to or greater than the diameter of the circular opening 21. In other words, the contact area 18 is configured to surround the circular opening 21 and to ensure effective picking of the cheese F.

In addition to this, advantageously, the contact area 18 lies on a substantially cylindrical surface having a predefined radius of curvature.

In detail, in accordance with the embodiment shown in the figures, the predefined radius of curvature corresponds to the radius of curvature of the outer surface 19 of the supply station 3.

In this way, the contact area 18 is configured to adhere substantially completely to the outer surface 19.

As stated above, the picking of the cheese F is carried out by means of the gripping portions 8.

The gripping portions 8 are configured to operate in conjunction with the holding body 9 during the transfer of the cheese F.

Conveniently, the gripping portions 8 are mutually and simultaneously movable with respect to a central axis C substantially parallel to the operational direction T.

For this purpose, the gripping unit 7 comprises an actuator body 23 supporting the gripping portions 8. In accordance with the embodiment shown in the figures, the actuator body 23 is of the type of a parallel gripper.

Advantageously, each gripping portion 8 has a substantially flat conformation and is arranged parallel to the central axis C.

Such conformation of the gripping portions 8 allows for an increased gripping surface area on the cheese F and reduces the risk of excessive deformation of the same.

The gripping portions 8 are configured to fit within the extremal portion 22. In detail, with the holding body 9 in the first position, the gripping portions 8 are surrounded by the extremal portion 22 and protrude at least partly therefrom, through the contact area 18.

The gripping portions 8 are defined on respective retaining elements 24 associated with the actuator body 23. In detail, each of the retaining elements 24 comprises the gripping portion 8 and a main portion 25, positioned between the actuator body 23 and the gripping portion 8.

In accordance with the embodiment shown in the figures, the main portion 25 has a substantially “S”-shaped conformation. This conformation allows optimization of the overall dimensions of the manipulation gripper and enables effective operation of the retaining elements 24 with respect to the holding body 9.

The main portions 25 run in the same plane to which the central axis C belongs. In other words, the central axis C is parallel to an operational axis W of the actuator body 23.

For this purpose, in addition, the extremal portion 22 also comprises a chamfer 26 configured to accommodate one of the main portions 25, with the holding body 9 in the first position.

Advantageously, the manipulation gripper 1 also comprises at least one movement assembly 27 associated with the working assembly 6 and adapted to move the latter in rotation around an axis of rotation R transverse to the operational direction T.

In accordance with the embodiment shown in the figures, the axis of rotation R is substantially horizontal.

The movement assembly 27 allows the rotation of the working assembly 6 depending on the various stages of transfer.

In fact, as shown in the figures, at one stage of picking, the working assembly 6 can be rotated to fit the outer surface 19, after which the holding body is arranged horizontally to allow the cheese F to be held and, finally, arranged vertically to allow it to be released by gravity.

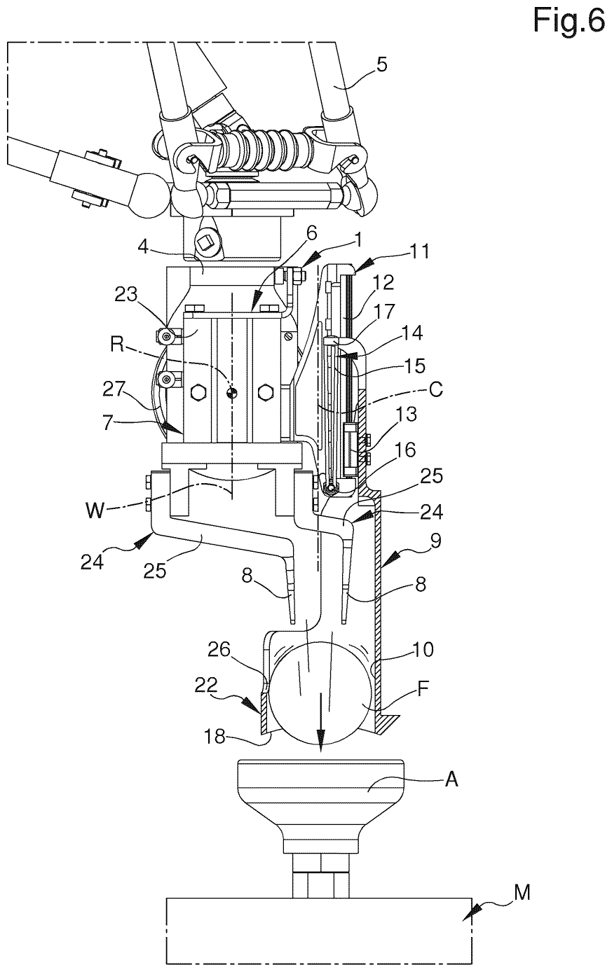

In the release stage, in fact, the retaining elements 24 are moved to allow loosening of the grip by the gripping portions 8 and at that point the cheese drops onto an appropriate container A by gravity (FIG. 6).

The movement assembly 27 comprises an electric motor.

According to a further aspect, the present invention also relates to a piece of equipment 2 for the transfer of stretched cheese of the fresh type.

The piece of equipment 2 comprises:
at least one base frame;
at least one supply station 3, as previously described, adapted to supply a plurality of stretched cheese F of the fresh type;
automated positioning means 5, as previously described, associated with the base frame and adapted to transfer the cheese F from the supply station 3 to a machine M for working the cheese F.

As stated above, the machine M for working the cheese F can be e.g. a burrata production machine.

According to the invention, the piece of equipment 2 comprises at least one manipulation gripper 1 according to one or more of the embodiments described above, associated with the automated positioning means 5.

It has, in practice, been ascertained that the described invention achieves the intended objects, and in particular the fact is emphasized that the manipulation gripper according to the invention for stretched cheese of the fresh type makes it possible to reduce the risk of alterations in the aesthetic appearance and, in particular, in the conformation of the cheese.

In addition, this manipulation gripper enables quick and efficient transfer of cheese so as to preserve the elasticity and deformability thereof.

Finally, this manipulation gripper allows minimizing the risk of bacterial contamination.

1) Manipulation gripper (1) for stretched cheese of the fresh type comprising:
at least one base support (4) associable with automated positioning means (5) adapted to transfer stretched cheese (F) of the fresh type from a supply station (3) to a machine (M) for making said cheese (F); and
at least one working assembly (6) associated with said base support (4) which is adapted to grasp and hold said cheese (F) and comprising at least one gripping unit (7) provided with a pair of mutually movable gripping portions (8) to grip/release said cheese (F);
wherein the fact that said working assembly (6) comprises at least one holding body (9) provided with a resting surface (10) adapted to hold said cheese (F) and by the fact that said manipulation gripper (1) comprises at least one shifting unit (11) positioned between said gripping unit (7) and said holding body (9) and adapted to mutually move said gripping unit (7) and said holding body (9) along an operational direction (T) between at least one first position, wherein said resting surface (10) is moved away from said gripping portions (8) and the latter are adapted to intercept said cheese (F), and at least a second position, wherein said resting surface (10) is arranged in the proximity to said gripping portions (8) and is adapted to hold said cheese (F).

2) Manipulation gripper (1) according to claim 1, wherein the fact that said shifting unit (11) comprises at least one guiding element (12) associated with said gripping unit (7), extending along said operational direction (T) and supporting said holding body (9) by sliding between said first position and said second position.

3) Manipulation gripper (1) according to claim 1, wherein the fact that said shifting unit (11) comprises retaining means (14) adapted to retain said holding body (9) in said second position, said holding body (9) being movable from said second position to said first position as a result of the movement of said manipulation gripper (1) against said supply station (3).

4) Manipulation gripper (1) according to claim 1, wherein the fact that said retaining means (14) comprise at least one elastic retaining element (15) positioned between said holding body (9) and said guiding element (12).

5) Manipulation gripper (1) according to claim 1, wherein the fact that said holding body (9) comprises a contact area (18) adapted to contact said supply station (3), said contact area (18) being configured to adhere at least partly to an outer surface (19) of said supply station (3).

6) Manipulation gripper (1) according to claim 1, wherein the fact that said holding body (9) comprises an extremal portion (22) having a substantially cylindrical conformation and defining said resting surface (10) and said contact area (18), said contact area (18) having a substantially annular development.

7) Manipulation gripper (1) according to claim 1, wherein the fact that said contact area (18) lies on a substantially cylindrical surface having a predefined radius of curvature.

8) Manipulation gripper (1) according to claim 1, wherein the fact that said gripping portions (8) are mutually and simultaneously movable with respect to a central axis (C) substantially parallel to said operational direction (T).

9) Manipulation gripper (1) according to claim 1, wherein the fact that each of said gripping portions (8) has a substantially flat conformation and is arranged parallel to said central axis (C).

10) Manipulation gripper (1) according to claim 1, wherein the fact that it comprises at least one movement assembly (27) associated with said working assembly (6) and adapted to move the latter in rotation around an axis of rotation (R) transverse to said operational direction (T).

11) Equipment (2) for the transfer of stretched cheese of the fresh type, comprising:
at least one base frame;
at least one supply station (3) adapted to supply a plurality of stretched cheese (F) of the fresh type;
automated positioning means (5) associated with said base frame and adapted to transfer said cheese (F) from said supply station (3) to a machine (M) for working said cheese (F);
wherein the fact that it comprises at least one manipulation gripper (1) according to claim 1, associated with said automated positioning means (5).
